(19) United States
(12) Patent Application Publication
(10) Pub. No.: US 2009/0259827 A1
(43) Pub. Date: Oct. 15, 2009

(54) SYSTEM, METHOD, AND COMPUTER PROGRAM PRODUCT FOR CREATING DEPENDENCIES AMONGST INSTRUCTIONS USING TAGS

(76) Inventors: Ricardo Ramirez, Sunnyvale, CA (US); Gaurav Singh, Los Altos, CA (US); Srivatsan Srinivasan, San Jose, CA (US)

Correspondence Address: ZILKA-KOTAB, PC- RMI, P.O. BOX 721120, SAN JOSE, CA, 95172-1120, US

(21) Appl. No.: 12/102,473

(22) Filed: Apr. 14, 2008

(51) Int. Cl. G06F 9/30

(52) U.S. Cl. 712/216; 712/E09.016

(57) ABSTRACT

A system, method, and computer program product are provided for creating dependencies amongst instructions using tags. In operation, tags are associated with a first instruction and a second instruction. Additionally, a dependency is created between the first instruction and the second instruction, utilizing the tags. Furthermore, the first instruction and the second instruction are executed in accordance with the dependency.

### FIELD OF THE INVENTION

The present invention relates to computing, and more particularly to instruction execution in computing environments.

### BACKGROUND

In a central processing unit (CPU) with a superscalar pipe-line and out-of-order execution, ensuring that an architectural state is updated at an architecturally correct boundary is not easy. Typical implementations use features such as register renaming and re-order buffers to enforce the correct order of updates to the architectural state. However, these features are expensive in both resources and complexity, especially for ensuring updates to architectural states that are not performance critical.

There is thus a need for addressing these and/or other issues associated with the prior art.

### SUMMARY

A system, method, and computer program product are provided for creating dependencies amongst instructions using tags. In operation, tags are associated with a first instruction and a second instruction. Additionally, a dependency is created between the first instruction and the second instruction, utilizing the tags. Furthermore, the first instruction and the second instruction are executed in accordance with the dependency.

### DESCRIPTION OF THE DRAWINGS

FIG. 1 shows a method for creating dependencies amongst instructions using tags, in accordance with one embodiment.

FIG. 2 shows a system for creating/enforcing dependencies amongst instructions using tags, in accordance with one embodiment.

FIG. 3 shows a method for creating dependencies amongst instructions using tags, in accordance with another embodiment.

FIG. 4 shows an example of enforcing/creating dependencies amongst instructions using tags, in accordance with one embodiment.

FIG. 5 illustrates an exemplary system in which the various architecture and/or functionality of the various previous embodiments may be implemented.

### DETAILED DESCRIPTION

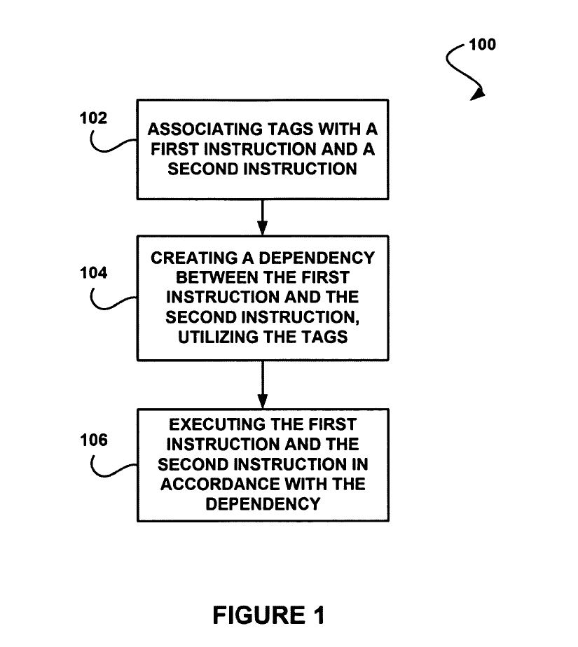

FIG. 1 shows a method 100 for creating dependencies amongst instructions using tags, in accordance with one embodiment. As shown, tags are associated with a first instruction and a second instruction. See operation 102.

In the context of the present description, a tag refers to any unique identifier. For example, in various embodiments, the tag may include, but is not limited to, a reorder buffer entry, a source identifier, a destination identifier, and/or any other identifier that meets the above definition.

Further, in the context of the present description, an instruction refers to any command or operation capable of being executed. For example, in various embodiments, the instruction may include, but is not limited to, a register access instruction, a non-rename register access instruction, an algorithmic operation, a computation, a read instruction, a write instruction, and/or any other instruction that meets the above definition.

Additionally, a dependency is created between the first instruction and the second instruction, utilizing the tags. See operation 104. In this case, a dependency refers to any dependence between instructions. For example, in various embodiments, the dependency may include, but is not limited to, an execution dependency, an issue dependency, a retire dependency, and/or any other dependency that meets the above definition.

In this case, an execution dependency refers to a dependency upon an instruction being executed. An issue dependency refers to a dependency upon an instruction being issued. Similarly, a retire dependency refers to a dependency upon an instruction being retired.

As shown further, the first instruction and the second instruction are executed in accordance with the dependency. See operation 106. For example, the dependency may control an order in which the first instruction and the second instruction are executed, relative to each other. In one embodiment, the dependency may control the execution for synchronizing at least one of reads and writes to a register.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

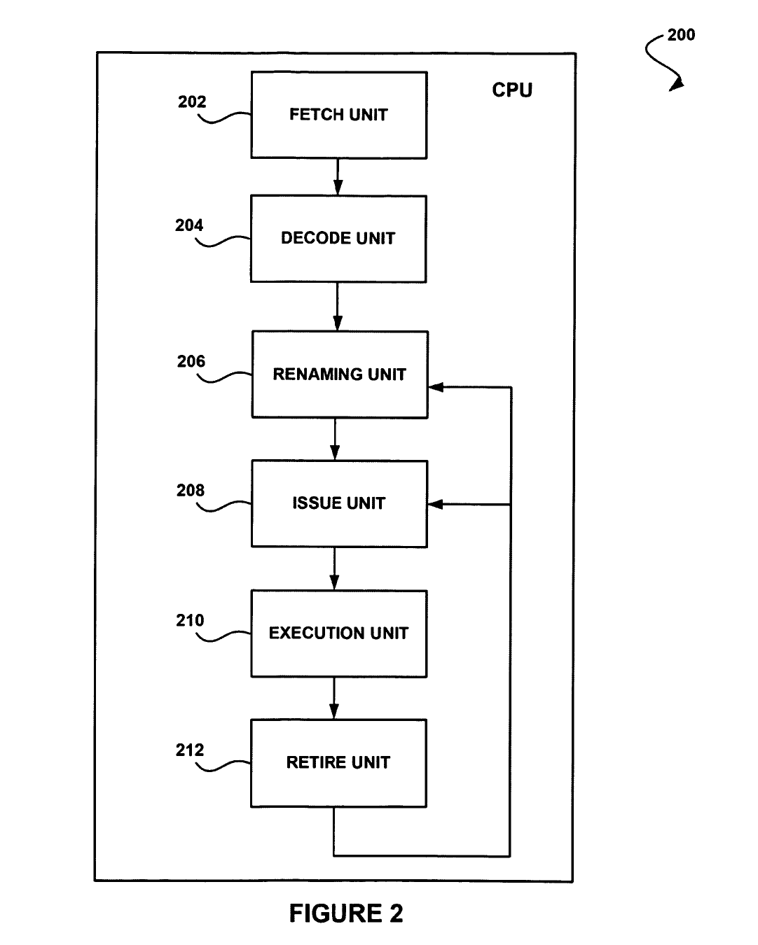

FIG. 2 shows a system 200 for creating/enforcing dependencies amongst instructions using tags, in accordance with one embodiment. As an option, the present system 200 may be implemented to carry out the method 100 of FIG. 1. Of course, however, the system 200 may be implemented in any desired environment. It should also be noted that the aforementioned definitions may apply during the present description.

As shown, a fetch unit 202 is provided. In operation, the fetch unit 202 may be used to fetch or retrieve instructions. Additionally, a decode unit 204 is provided. The decode unit 204 may be used to decode the instructions retrieved by the fetch unit 202.

As shown further, a renaming unit 206 is provided. In operation, the renaming unit 206 may be used to perform a register renaming operation. For example, the renaming unit 206 may be used to map a logical register to at least one physical register.

In one embodiment, the renaming unit 206 may include a mapping table. The mapping table may include information to map a plurality of logical registers to a plurality of physical registers. For example, the mapping table may be used to determine which logical register maps to which physical register or plurality of registers.

Additionally, an issue unit 208 is provided. In one embodiment, the issue unit 208 may be used to delegate or route instructions to a floating point unit, a load/store unit, or any other instruction processing unit, storing unit, or instruction processing pipeline. For example, if the instruction is a floating point instruction, the issue unit 208 may route the instruction to the floating point unit. On the other hand, if the instruction is a load/store instruction, the issue unit 210 may route the instruction to the load/store unit.

As an option, the floating point unit may include a floating point register file. The floating point register file may be a physical register file which is used to store floating point data. The load/store unit may also include a physical register file. For example, the mapping table may include information which maps a logical register to a physical register in the load/store unit. In such case, the issue unit 208 may route the load/store instruction to the physical register in the load/store unit based on the information included in the mapping table.

As shown further, an execution unit 210 is provided for executing instructions. Additionally, a retire unit 212 is provided. As an option, the retire unit 212 may be utilized to free tags and release any retire dependencies.

In operation, the fetch unit 202 may be utilized to fetch one or more instructions. The decode unit 204 and the renaming unit 206 may then be utilized to associate tags with a first instruction and a second instruction and create a dependency between the first instruction and the second instruction, utilizing the tags. The dependency may be determined based on many factors such as the instruction type (i.e. branch, load/store, ALU) or by a common resource (i.e. non-renamed registers or TLB) use by multiple instructions.

Subsequently, the issue unit 208 may determine whether the dependency has been met. Furthermore, the first instruction and the second instruction may be executed by the execution unit 210 in accordance with the dependency. In one embodiment, the dependency may control the execution for synchronizing at least one of reads and writes to a register. In this case, the dependency may control the execution for synchronizing at least one of reads and writes to a non-renamed register.

For example, in one embodiment, tracking logic may tag the instruction with an identifier for the instruction just before the current instruction. Because no instructions following the current instruction can issue until after the current instruction has issued, the tracking logic may assign and remember a unique identifier for the “retire gate ” struction. This may be referred to as an “issue gate.”

In this case, the “retire gate” refers to the tag assigned to a first instruction which will be used to prevent another instruction (or instructions) from issuing until the first instruction retires. The “issue gate” refers to the tag assigned to a first instruction which will be used to prevent another instruction (or instructions) from issuing until the first instruction issues.

As an example of how these are used, an instruction I1 may be examined, I1 being included in a larger set of instructions which writes into a non-renamed instruction. In this case, the larger set of instructions is illustrated in Table 1 below.

TABLE 1

| | |
|---|---|
| I0 | |
| I1 | writes non-renamed register |
| I2 | |
| I3 | reads non-renamed register |

This list of instructions is in program order. Thus, instruction I0 retires before I1 and I1 retires before I2, etc. Since instruction I1 writes into a non-renamed instruction, all instructions prior to I1 need to retire to ensure that I1 will go through. Accordingly, for instruction I0, a tag is assigned to I0 to use as a retire dependency for I1. This tag is called a retire gate. In this case, instruction I1 cannot issue until I0 retires. I3 reads the same non renamed register, so it needs to be ensured I3 does not get executed ahead of I1. Thus, for instruction I1, a tag is assigned to I1 to use as an issue dependency for I3. This tag is called an issue gate. Accordingly, instruction I3 cannot issue until I1 issues.

In one embodiment, the decode/classification logic may identify an instruction which reads or uses the non-renamed register from the previous write. The tracking logic may tag this new instruction with the “issue gate” from the instruction that writes the non-renamed register. In this case, the issue logic will not issue the non-renamed write instruction until the instruction identified by the “retire gate” retires. Furthermore, the issue logic will not issue the non-renamed register read instruction(s) until the instruction identified by the “issue gate” is issued.

As an option, the dependency may control the execution of the first instruction and the second instruction for debugging purposes. For example, by creating a particular order in which instructions are issued with respect to each other, an embodiment can avoid bugs by preventing the conditions that expose the bug. In addition, an embodiment can reduce functionality so that testing may progress despite the presence of bugs. For example, if the system 200 is to handle out-of order branch execution, but that feature turns out to have bugs, branch instructions may be forced to execute in-order.

As yet another option, the issuance and execution of instructions may be synchronized for debugging purposes. For example, this may include forcing all instructions to issue in-order, creating dependencies between different instructions which normally would not have any dependencies, and creating dependencies based on certain instruction characteristics such as an instruction PC, and instruction type, etc.

In still another embodiment, the dependency may control the execution of the first instruction and the second instruction in a multi-threaded environment. For example, the issuance of a first instruction to a first thread may depend on the execution of a second instruction on a second thread. Thus, upon execution of the second instruction using the second thread, the first instruction may be issued. Furthermore, dependencies may be created or enforced between a shared resource between threads (e.g. a register, etc.), or artificial dependencies may be created between threads such that control may be exercised over how one thread issues instructions with respect to when instructions of another thread are issued, executed, or retired.

Once the instruction has been executed, the retire unit 212 may be utilized to free any tags and release any retire dependencies. In one embodiment, the freed tags may be stored in a pool including all free tags. As an option, this pool may be used to retrieve tags to allocate to instructions.

It should be noted that the system 200 may be utilized to create and/or enforce dependencies. For example, the system 200 may be utilized to enforce dependencies between instructions corresponding to non-renamed registers. Additionally, the system 200 may be utilized to create dependencies to attain a desired behavior such as in-order execution of branches to avoid a bug. Further, issue and retire dependencies may be utilized to control when instructions are issued such that changes to architectural states are observed in the correct order.

As an option, the issuance and execution of instructions for reading or writing non-renamed architectural registers may be synchronized. For example, in a MIPS (Microprocessor without Interlocked Pipeline Stages) architecture, these non-renamed architectural registers include a majority of COP0 (coprocessor-0) registers, COP1 (coprocessor-1) registers, and COP2 (coprocessor-2) registers. Additionally, updates and uses of non-renamed registers may be synchronized. For example, decode/classification logic may identify an instruction which writes into a non-renamed register. Since this instruction writes into a non-renamed register, the register cannot be written until all previous instructions have retired.

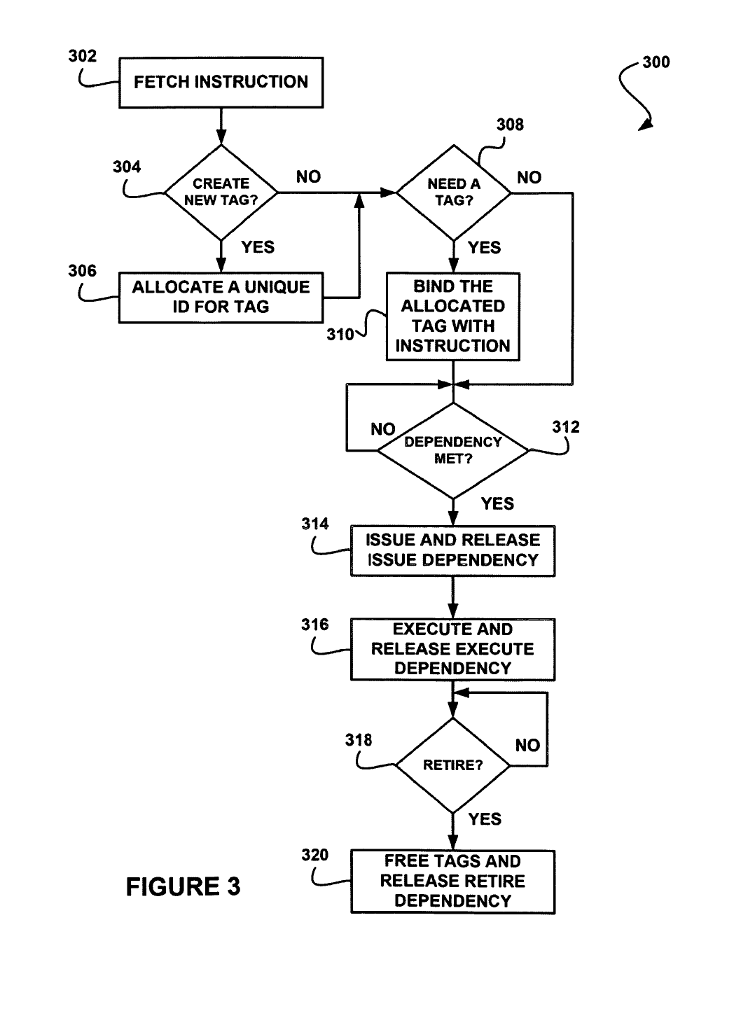

In one embodiment, the tags may be utilized to enforce a dependency between a plurality of instructions and an instruction preceding the plurality of instructions. For example, a tag may be used to make an issue time of several instructions dependent on a common predecessor. Further, as an option, the tags may be utilized to control an amount of speculation an out-of-order (OOO) processor can perform. 100381 FIG. 3 shows a method 300 for creating dependencies amongst instructions using tags, in accordance with another embodiment. As an option, the present method 300 may be implemented in the context of the functionality and architecture of FIGS. 1-2. Of course, however, the method 300 may be carried out in any desired environment. Again, the aforementioned definitions may apply during the present description.

As shown, an instruction or a plurality of instructions are fetched. See operation 302. It is then determined whether to create a new tag for the instruction. See operation 304. If it is determined that a new tag is to be created, a unique identifier is allocated for a tag. See operation 306.

As an option, each of the tags created may be unique to a corresponding instruction. Furthermore, the tags may be associated with one or more instructions independent of resources utilized for the execution. In one embodiment, the unique identifier may be allocated to the tag utilizing a decode unit, such as the decode unit described in the context of FIG. 2.

Once the unique identifier is allocated for the tag, or if it is determined that a new tag is not to be created, it is then determined whether a tag is needed for the instruction. See operation 308. For example, the instruction may include information associated with another instruction corresponding to another allocated tag. In other words, the instruction may be dependent upon other instructions which have associated tags. In one embodiment, decode/classification logic may be utilized to identify instructions which are dependent on each other.

If a tag is needed for the instruction, the allocated tag is bound with the instruction. See operation 310. In one embodiment, the tags may be associated with a first instruction and a second instruction by binding the tags with a first instruction and a second instruction. As an option, the binding of the tag with the instruction may be accomplished using a decode and/or renaming unit, such as the decode and renaming units described in the context of FIG. 2.

As shown further, it is then determined whether any dependency has been met. See operation 312. In this case, the dependency may include any dependency such as an execution dependency, an issue dependency, and a retire dependency. For example, if a first instruction is dependant upon the issuance of a second instruction, and the second instruction has not yet been issued, the first instruction may be held until the second instruction is issued.

Similarly, if the first instruction is dependent upon the execution of a second function, the first instruction may be held until the second instruction is executed. Additionally, if the first instruction is dependent upon the retiring of the second instruction, the first instruction may be held until the second instruction is retired. As an option, an issue unit, such as the issue unit described in the context of FIG. 2, may be utilized to determine whether the dependency has been met.

Once the dependency has been met, the instruction is issued and any issue dependency associated with the instruction is released. See operation 314. For example, if a first instruction depends on the issuance of a second instruction, upon issuance of the second instruction, all issue dependencies may be released and the first instruction may be issued or executed.

Once the instruction is issued, the instruction is executed and any execute dependencies are released. See operation 316. Thus, any other instruction depending on the execution of that instruction may move forward in processing (e.g. issuance, execution, retirement, etc.). Once the instruction is executed, it is determined whether the instruction is to be retired. See operation 318.

If it is determined that the instruction is to be retired, tags associated with that instruction are freed and any retire dependencies are released. See operation 320. By freeing the tags, the freed tags may be stored and reused for other instructions.

In this way, as each instruction is dispatched, the instruction may be assigned a unique tag for as long as it remains un-retired in a CPU. To serialize a first instruction with respect to a second instruction, the tag of the first instruction may accompany the second instruction to instruction issue logic. Thus, the tag of the first instruction may be used as a dependency on the issue of the second instruction, for example.

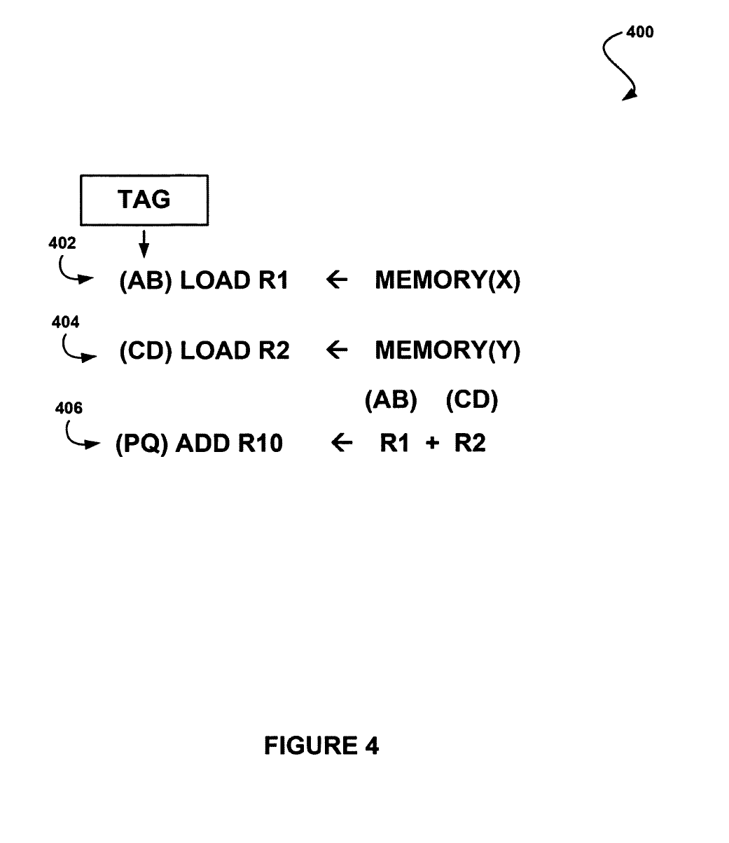

FIG. 4 shows an example 400 of enforcing/creating dependencies amongst instructions using tags, in accordance with one embodiment. As an option, the present example 400 may be viewed in the context of the functionality and architecture of FIGS. 1-3. Of course, however, the example 400 may be viewed in the context of any desired environment. Further, the aforementioned definitions may apply during the present description.

As shown, a first instruction 402, a second instruction 404, and a third instruction 406 are provided. As shown further, each of the instructions 402-406 have an associated tag “AB,” “CD,” and “PQ” respectively. In this case, the first instruction 402 is a load instruction that involves loading data from a logical register R1 corresponding to memory “X.” The second instruction 404 is a load instruction that involves loading data from a logical register R2 corresponding to memory “Y.” The third instruction 406 is an arithmetic operation involving the addition of data associated with R1 and R2 to a logical register R10. 100511 In operation, the instruction 402 is fetched and the tag AB is allocated to the instruction 402. In one embodiment, the tag AB may be obtained from a free pool of tags. It is then determined whether all dependencies have been met for the instruction 402, and if so, the instruction is issued and executed and R1 is loaded.

Similarly, the instruction 404 is fetched and the tag CD is allocated to the instruction 404. It is then determined whether all dependencies have been met for the instruction 404, and if so, the instruction is issued and executed and R2 is loaded. It should be noted that the instructions 402 and 404 may be fetched at the same time or serially.

Additionally, the third instruction 406 may also be fetched at the same time as the instructions 402 and 404. Once the third instruction 406 is fetched and the tag PQ is allocated to the instruction, it is then determined whether any tags should be bound to the third instruction 406. In this case, because the third instruction 406 depends on the first and second instructions 402 and 404, the tags AB and CD are bound to the third instruction 406.

Using these tags, it is then determined whether all dependencies have been met. In this case, the issuance of the third instruction 406 depends on the first and second instructions 402 and 404 being executed. Thus, the tags AB and CD associated with the first and second instructions 402 and 404 may be utilized to determine whether those instructions have been issued and/or executed.

If the first and second instructions 402 and 404 have been executed, the third instruction 406 is issued and executed. If the first and/or second instructions 402 and 404 have not been executed, the third instruction 406 is held in a queue until the execution dependencies have been fulfilled. In this case, the queue may be an issue queue included in an issue unit, such as the issue unit described in the context of FIG. 2.

In one embodiment, tracking logic may be utilized to track the tag assigned to an instruction for later use to create a dependency to later instructions. For example, the tracking logic may be utilized to track tags AB and CD in the case that the first and second instructions 402 and 404 were issued or executed in advance of the issuance of the third instruction 406. Furthermore, instruction issue logic may use the tags to enforce the created dependencies.

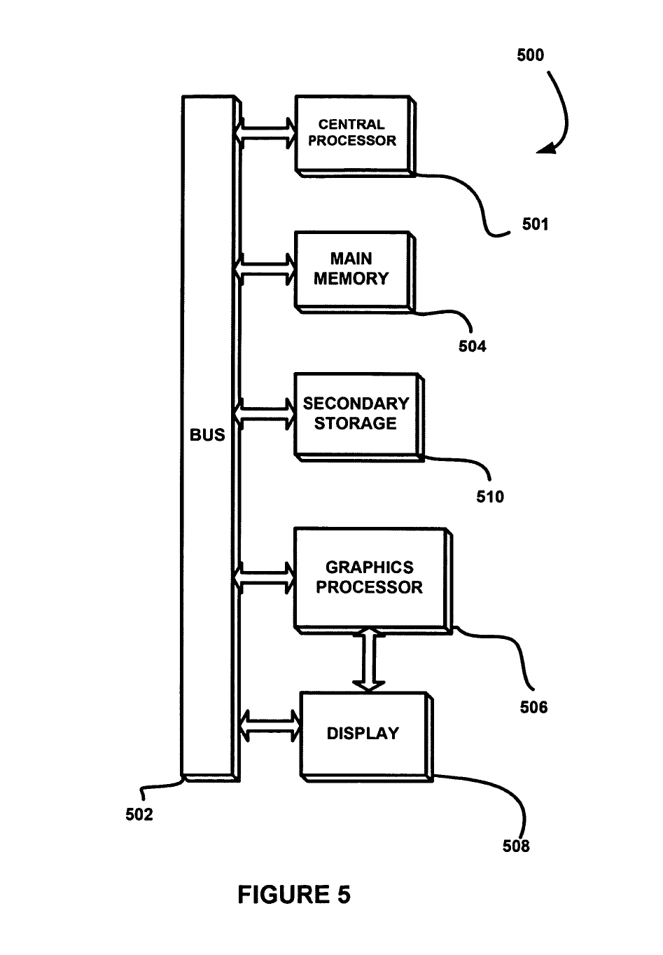

FIG. 5 illustrates an exemplary system 500 in which the various architecture and/or functionality of the various previous embodiments may be implemented. As shown, a system 500 is provided including at least one host processor 501 which is connected to a communication bus 502. The system 500 also includes a main memory 504. Control logic (software) and data are stored in the main memory 504 which may take the form of random access memory (RAM).

The system 500 also includes a graphics processor 506 and a display 508, i.e. a computer monitor. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 504 and/or the secondary storage 510. Such computer programs, when executed, enable the system 500 to perform various functions. Memory 504, storage 510 and/or any other storage are possible examples of computer-readable media.

In one embodiment, the architecture and/or functionality of the various previous figures may be implemented in the context of the host processor 501, graphics processor 506, an integrated circuit (not shown) that is capable of at least a portion of the capabilities of both the host processor 501 and the graphics processor 506, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, lap-top computer, and/or any other type of logic. Still yet, the system 500 may take the form of various other devices including, but not limited to, a personal digital assistant (PDA) device, a mobile phone device, a television, etc.

Further, while not shown, the system 500 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
associating tags with a first instruction and a second instruction;
creating a dependency between the first instruction and the second instruction, utilizing the tags; and
executing the first instruction and the second instruction in accordance with the dependency.

2. The method of claim 1, wherein the dependency includes an execution dependency.

3. The method of claim 1, wherein the dependency includes an issue dependency.

4. The method of claim 1, wherein the dependency includes a retire dependency.

5. The method of claim 1, wherein each of the tags are unique to a corresponding one of the first instruction and the second instruction.

6. The method of claim 1, wherein the tags are associated with the first instruction and the second instruction independent of resources utilized for the execution.

7. The method of claim 1, wherein the dependency controls an order in which the first instruction and the second instruction are executed, relative to each other.

8. The method of claim 1, wherein the dependency controls the execution for synchronizing at least one of reads and writes to a register.

9. The method of claim 8, wherein the register includes a non-renamed register.

10. The method of claim 1, wherein the dependency controls the execution of the first instruction and the second instruction for debugging purposes.

11. The method of claim 1, wherein the dependency controls the execution of the first instruction and the second instruction in a multi-threaded environment.

12. The method of claim 1, wherein the tags are associated with the first instruction and the second instruction by binding the tags with the first instruction and the second instruction.

13. A system, comprising:
a first unit operable to associate tags with a first instruction and a second instruction to create or enforce a dependency between the first instruction and the second instruction, utilizing the tags; and
a second unit in communication with the first unit, the second unit operable to execute the first instruction and the second instruction in accordance with the dependency.

14. The system of claim 13, wherein the dependency includes an execution dependency.

15. The system of claim 13, wherein the dependency includes an issue dependency.

16. The system of claim 13, wherein the dependency includes a retire dependency.

17. The system of claim 13, wherein each of the tags are unique to a corresponding one of the first instruction and the second instruction.

18. The system of claim 13, wherein the tags are associated with the first instruction and the second instruction independent of resources utilized for the execution.

19. The system of claim 13, wherein the dependency controls an order in which the first instruction and the second instruction are executed.

20. The system of claim 13, wherein the first unit and the second unit are integrated on a processor coupled to memory via a bus.

21. The system of claim 13, wherein the tags are utilized to enforce the dependency between a plurality of instructions and an instruction preceding the plurality of instructions.

22. The system of claim 21, wherein the dependency is one of an issue dependency, an execute dependency, or a retire dependency.

23. The system of claim 13, wherein the dependency is determined based on one of a branch instruction, a load instruction, and a store instruction.

24. The system of claim 13, wherein the tags are utilized to control an amount of speculation an out-of-order (OOO) processor is able to perform.

25. A computer program product embodied on a tangible computer readable medium, comprising:
computer code for associating tags with a first instruction and a second instruction;
computer code for creating a dependency between the first instruction and the second instruction, utilizing the tags; and
computer code for executing the first instruction and the second instruction in accordance with the dependency.
